(19) United States
(12) Patent Application Publication
(10) Pub. No.: US 2005/0033918 A1
(43) Pub. Date: Feb. 10, 2005

(54) Data storage apparatus

(76) Inventor: Guy de Warrenne Bruce Adams, Stroud (GB)

Correspondence Address: HEWLETT-PACKARD COMPANY;Intellectual Property Administration, P.O. Box 272400, Fort Collins, CO, 80527-2400, US

(21) Appl. No.: 10/883,948

(22) Filed: Jul. 2, 2004

(30) Foreign Application Priority Data
Jul. 4, 2003 (GB) 0315692.4

(51) Int. Cl. G06F 12/00

(52) U.S. Cl. 711/115; 711/103; 711/154

(57) ABSTRACT

Embodiments of the data storage apparatus provide a system and method for storing data in a disconnectably coupled device. Briefly described, one embodiment is a data storage apparatus arranged to be disconnectably coupled to a host device, the data storage apparatus comprising: a first data storage device arranged to store data received from the host device; and a data transfer device arranged to receive a removable data storage medium and arranged to store data received from the host device on the removable data storage medium, wherein the data storage apparatus is arranged to store data selectively on at least one of the first data storage device and the removable data storage medium.

### CLAIM TO PRIORITY

This application claims priority to copending United Kingdom utility application entitled, “Data Storage Aparatus,” having serial no. GB 0315692.4, filed Jul. 4, 2003, which is entirely incorporated herein by reference.

### TECHNICAL FIELD

Embodiments are generally related to data storage and, more particularly, is related to a system and method for storing data in a disconnectably coupled device.

### BACKGROUND

With the increasing use of digital devices, including digital still and video cameras and personal digital assistants, there is a corresponding increasing demand for removable digital data storage devices. One example of such removable digital storage is the Flash card. A Flash card is a solid state memory device on to which data can be written and subsequently retrieved. However, the cost of such solid state memory cards is relatively high such that they are not perceived by the majority of users as being suitable for long term data storage. Rather, the majority of users perceive solid state memory cards as temporary data storage, with the data stored thereon being transferred or copied to a long term data storage device relatively soon after it has been stored on the memory card. The original data is then deleted from the memory card such that new data may be stored thereon, or the new data simply overwrites the previous data. This is in contrast to a video cassette or conventional 3.5 inch diskette. From a user's point of view, these latter devices are cheap enough for data to be recorded thereon once only to provide permanent storage for the data. Hence from a user's perspective, the two types of data storage medium are not comparable.

A further inhibition from a user's perspective against solid state memory cards is the time overhead necessary in downloading the data stored on the memory cards to the subsequent data storage device that the user has denoted as long term storage. One example of this is the use of memory cards in digital cameras. Although each memory card can store tens of still digital photographs, the user is still required to download the stored photographs from the memory card to a further memory storage device, for example the hard disk of a personal computer, to allow fresh data to be stored on the memory card. As stated previously, the cost of the memory card prejudices the user against treating it as Read Only Memory.

The problem is exacerbated for the use of such memory cards for digital video as the amount of video footage that can be stored on such memory cards is generally very limited. Attempts have been made to overcome this disadvantage. For example, digital video cameras have been provided having both a conventional tape drive and a solid state memory card. The reasoning behind such devices is that the conventional tape is used to store the video footage, with the solid state memory card being used to store still photographs. However, this solution has its own disadvantages in that there is a significant cost overhead in providing the separate read/write mechanisms and associated control logic within the host device for both the memory card and video tape. Additionally, the choice of available data formats for the stored data is restricted to those suitable to be stored on the memory card or video tape, or whatever additional storage medium is provided. The two data storage mediums supported by the host device are alternatives to one another and there is no flexibility in the manner in which the data is stored.

FIG. 1 illustrates a digital video camera according to the prior art. The camera 2 is capable of taking both conventional video footage and also digital still photographs. A conventional magnetic video tape 4 can be inserted into the tape drive 6 in the camera 2 to allow video footage to be stored on the video tape 4. Additionally, a solid state memory card 8 capable of storing, for example, but not limited to, 128 MB of data can be inserted into a memory card slot 10 in the camera 2 to allow digital photographs to be stored on the memory card 8.

### SUMMARY

The data storage apparatus provides a system and method for storing data. Briefly described, one embodiment is a data storage apparatus arranged to be disconnectably coupled to a host device, the data storage apparatus comprising: a first data storage device arranged to store data received from the host device; and a data transfer device arranged to receive a removable data storage medium and arranged to store data received from the host device on the removable data storage medium, wherein the data storage apparatus is arranged to store data selectively on at least one of the first data storage device and the removable data storage medium.

Another embodiment is a data storage device for providing storage of data from a digital device, the data storage device comprising; an interface configured to enable the data storage device to be disconnectably coupled to a digital device; a first data storage medium coupled to the interface and arranged to selectively store data received from the digital device via the interface; and a data transfer device coupled to the interface and configured to receive a second, removable, data storage medium, the data transfer device being arranged to selectively store data received from the digital device via the interface on the second, removable, data storage medium.

Another embodiment is a storage apparatus for providing storage of data from a host device, the data storage apparatus comprising: an interface providing means for disconnectably coupling the data storage apparatus to the host device; a first data storage device arranged to selectively store data received from the host device; a data transfer device configured to removably receive a second data storage device and arranged to selectively store data received from the host device on the second data storage device; and a data controller arranged to control the selection of each of the first data storage device and the data transfer device and control the storage of data received from the host device thereon.

Another embodiment is an image capture device, comprising: an interface arranged to be disconnectably coupled to either a data storage apparatus and a conventional memory device; a processor configured to discover if the image capture device is coupled to the data storage apparatus or the conventional memory device; and a data controller arranged to control the flow of data from the image capture device in accordance to at least one criteria when the image capture device is coupled to the data storage apparatus, wherein the data storage apparatus comprises a first data storage device and a data transfer device arranged to receive a removable data storage medium, and wherein the data storage apparatus stores the data received from the image capture device selectively into one of the first data storage device and the removable data storage medium depending upon the criteria.

Another embodiment is a method for storing data received from an image capture device into a storage apparatus disconnectably coupled to the image capture device, comprising: receiving data from the image capture device; determining a characteristic of the received data; storing the received data into a solid state memory medium when the determined characteristic corresponds to a first predefined characteristic; and storing the received data into a removable memory medium when the determined characteristic corresponds to a second predefined characteristic.

### BRIEF DESCRIPTION OF THE DRAWINGS

Embodiments of the present invention will be described below, by way of illustrative example only, with reference to the accompanying figures, of which:

FIG. 1 schematically illustrates a prior art digital video camera having both a video tape drive and a memory card slot;

FIG. 2 schematically illustrates a data storage apparatus according to an exemplary embodiment;

FIG. 3 schematically illustrates the use of the data storage device shown in FIG. 2 with a digital video camera; and

FIG. 4 is a flow chart illustrating a process used by the data storage apparatus of FIG. 2.

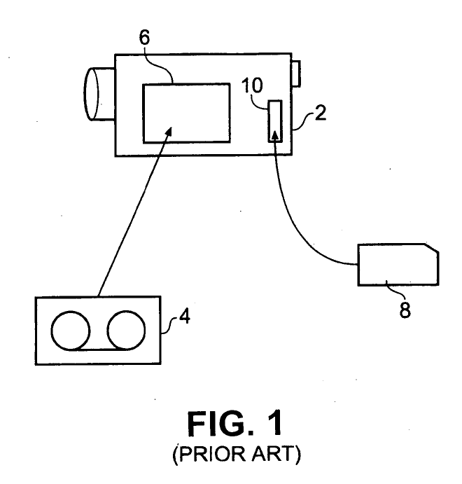

### DETAILED DESCRIPTION

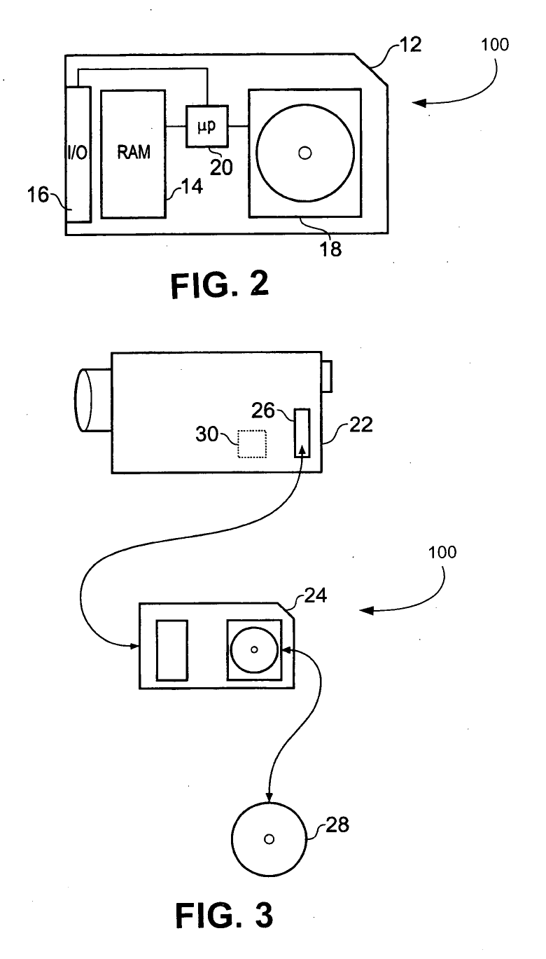

A data storage apparatus 100 according to an exemplary embodiment is shown in FIG. 2. The apparatus 100 is housed in a casing 12 that has the same physical dimensions as a conventional solid state memory card.

An example of such a conventional memory card is a solid-state floppy-disk card (SSFDC), more commonly known as SmartMedia (Registered as a Trademark to the Toshiba Corporation), and available in memory capacities from 2-128 MB. The external dimensions of a SSFDC are 45 mm long, 37 mm wide and less than 1 mm thick. A further example is a CompactFlash card, as developed by Scandisk. These are slightly physically larger than SmartMedia having external dimensions of 43 mm wide, 36 mm long and either 3.3 mm or 5.5 mm depth. Of course it will be appreciated that other solid state memory devices may be utilised, although it is preferable for them to conform to the technical standards set by the Personal Computer Memory Card International Association (PCMCIA).

Integrated within the data storage apparatus 100 is a conventional solid state memory 14, as is found within a conventional solid state memory card. An input/output interface (I/O) 16 is provided such that the data storage apparatus 100 can be used with a conventional solid state memory card interface.

In addition to the integrated memory 14, there is also provided a data transfer device 18 for use with removable storage media. For example, the data transfer device 18 may be an optical disk drive for use with mini optical disks. In one embodiment, the data transfer device is arranged to receive a removable data storage medium having a greater data storage capacity than the first data storage device 14.

In various embodiments, the data transfer device is that the associated storage medium is sufficiently inexpensive such that it is viewed by users as write once memory. Hence any appropriate storage device may be used, such as a magnetic disk drive or a solid state memory read/write device.

The casing 12 of the data storage apparatus 100 is provided with an access flap or slot, as is most appropriate for the design of the optical disk drive, to allow the associated storage medium, such as optical disks, to be inserted and removed from the casing 12.

Also within the casing 12 there is provided a microprocessor 20 that controls the operation of both the data transfer device 18 and the solid state memory 14.

In use, the microprocessor 20 (μp) controls the flow of data between the host device to which the data storage apparatus 100 can be coupled and the solid state memory 14 and the data transfer device 18 of the data storage apparatus. In one exemplary embodiment, the data transfer device 18 is an optical drive, and referred to hereinafter as such for convenience.

Only a single controller 20 is thus required for both data storage mediums. It is therefore possible to have a single data storage apparatus 100, or memory module, that allows short term data storage of data received from a host device by virtue of the first data storage device 14, in an analogous fashion to conventional solid state memory cards, yet also allows a removable data storage medium to be used for long term storage of the data from the host device in an analogous fashion to video tape or computer diskettes.

In some embodiments, the microprocessor 20 includes some memory that stores the software and data required by the microprocessor 20 to accomplish its controlling functions. Alternatively, an additional dedicated memory, such as, but not limited to, a programmable read only memory (PROM), may be provided for this purpose.

The microprocessor 20 is programmed in such a fashion that the data storage apparatus 100 appears as a conventional solid state memory card to the host device to which it is coupled. However, the microprocessor 20 controls the flow of data from the host device so as to utilise both the solid state memory 14 and the optical drive 18 in a number of different possible ways. In other words the data from the host device can be stored on either, or both, of the data storage mediums, according to one of a number of possible data flow schemes.

The provision of the microprocessor 20 within the data storage apparatus 100 allows the data storage apparatus 100 to be essentially self-controlled. This allows the data storage apparatus to be used with existing host devices, such as video or still cameras equipped with an appropriate memory card slot, that themselves do not include a data controller arranged to control the flow of data between the host device and the two data storage mediums present in the data storage apparatus 100. Additionally, the flow of data may be controlled in accordance with a user initiated control signal.

For example, the microprocessor 20 may be programmed to distinguish between data having different characteristics, for example video and/or audio data on the one hand and still photography data on the other hand, and to control the flow of data so as to store the video and/or audio data using the optical drive 18, whilst storing the still photo data on the solid state memory 14. This provides various advantages. Firstly, as the optical disk used with the optical drive 18 is likely to have a far higher data capacity than the solid state memory 14, for example up to 1 GB, significantly more video and/or audio data may be stored on the optical disk. Secondly, as the optical disk is removable from the data storage apparatus 100, it may be used in other consumer devices that are compatible. This would allow the optical disks to be treated in an analogous fashion as conventional video tapes have been in the past. Thirdly, the increased data storage provided by the optical drive 18 on the data storage apparatus 100 enables other user devices capable of being coupled to a conventional memory card to perform improved functionality. For example, a personal digital assistant having a memory card slot could be used to play video footage stored on the optical disk at a significantly lower cost to the user than is currently possible.

However it will be appreciated that the data stored on the solid state memory 14 and removable data storage medium (optical disk in the described embodiment) may still be mixed. For example, each still photograph may have some text associated with it. Such text may be an ‘aide memoir’ provided by the user relating to the subject of the photograph. Alternatively, or in addition to, the ‘aide memoir’ may be audio data. Consequently, the characteristics of the data used by the microprocessor 20 to differentiate between data need not be restricted only to the data type. The host device may be arranged to add a flag to the data denoting its preferred storage location, either automatically or in response to a user input.

Equally, the microprocessor 20 may be responsive to control signals initiated by a user via appropriate input means provided on a host device in which the data storage apparatus is inserted. This allows the user to determine which of the first and second data storage devices is used for any given kind of data.

Furthermore, the microprocessor 20 may be programmed to perform one or more ‘added-value’ functions. For example the microprocessor 20 may be programmed to construct a ‘slide-show’ of still photographs stored on the solid state memory 14 and copy or save it onto an optical disk using the optical disk drive 18 in a format that can be played on a further user device. This would allow the still photographs to be viewed by other users who do not have access to a solid state memory card reader. The programming of the processor 20 may be established at the time of manufacture or may be re-programmable by a user. The latter option allows the functionality of a data storage apparatus to be tailored to individual user's requirements.

In other embodiments of the present invention, the microprocessor 20 may utilise the solid state memory 14 to optimise local issues such as power management and the situation of abrupt power removable. For example, the solid state memory 14 may be used as a data buffer to conserve power, with a transfer of data from the solid state memory 14 to the optical disk drive 18 occurring periodically. This is more power efficient than operating the optical drive 18 continuously. The use of the solid state memory 14 as a buffer would also mitigate against data loss in a case of abrupt power removal.

FIG. 3 illustrates an example of the use of an embodiment of a data storage apparatus 100 with a digital video camera 22 as an exemplary host device. The storage apparatus 24, of the kind shown in FIG. 2, can be inserted into a conventional solid state memory card slot 26 provided in the camera 22. In the case of the embodiment shown in FIG. 2, the processor 20 of the data storage apparatus 24 subsequently controls the flow of data to and from the storage apparatus 24 and the camera 22. The removable optical disk 28 can subsequently be removed and used in other consumer devices in a conventional manner. In an alternative embodiment, an additional processor 30 may be provided within the camera 22 to control the flow of data to and from the data storage apparatus 24. However, the processor 20 integrated in the data storage apparatus 24 still controls other basic functions of the apparatus 100, such as interface functions. The provision of the processor 30 within the camera 22 transfers the “intelligence” from the data storage apparatus 24 to the camera 22 and allows the camera 22 to interrogate any data storage card coupled to the camera to discover if the card is a conventional solid state memory card or is an embodiment of a storage apparatus. The provision of the processor 30 and camera 22 would allow functionality to be provided in the camera 22 giving control of data storage to the user. For example, the user would be able to specify in which of the data storage devices, that is the solid state memory 14 or the optical drive 18, specific data is to be stored.

Other uses of embodiments of the data storage apparatus can be envisaged. For example, with a personal digital assistant to provide a data archiving function, with the archived data being stored on the removable data storage media, i.e. the optical disk 28, which in turn could be safely stored away from the personal digital assistant with the ability to be restored at a later date.

Although the above described embodiments of the present invention have referred to solid state memory as the ‘integrated’ storage device and an optical disk as the removable data storage medium, other combinations of available data storage devices and mediums may be used. The combination is likely to be selected in dependence on the anticipated characteristics of the data to be stored. For example, if it is expected that large data files will be stored on the removable storage medium a high density storage medium and appropriate data transfer device may be selected.

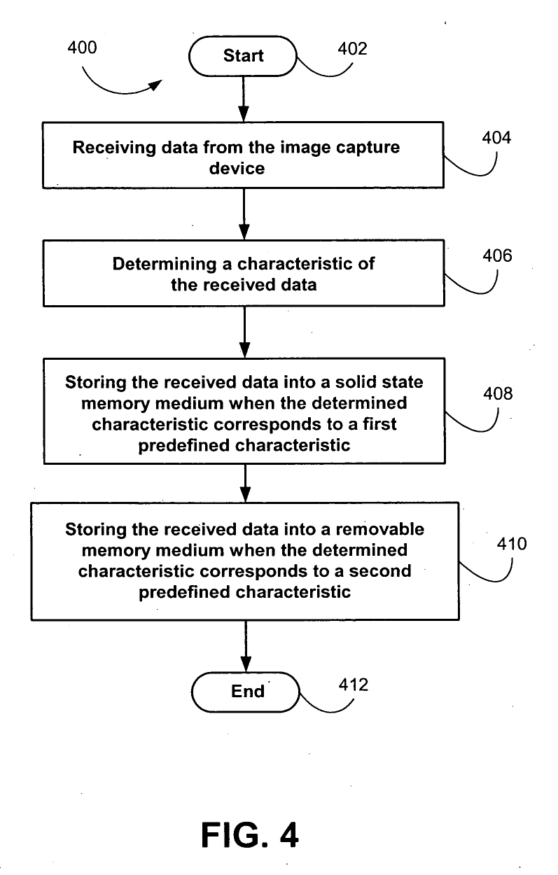

FIG. 4 is a flow chart 400 illustrating a process used by the data storage apparatus 100 of FIG. 2. The flow chart 400 shows the architecture, functionality, and operation of a possible implementation of the software for implementing the programming operated by the microprocessor 20 (FIG. 2) residing in the data storage apparatus 100. In this regard, each block may represent a module, segment, or portion of code, which comprises one or more executable instructions for implementing the specified logical function(s). It should also be noted that in some alternative implementations, the functions noted in the blocks may occur out of the order noted in FIG. 4 or may include additional functions. For example, two blocks shown in succession in FIG. 4 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure

The process starts at block 402. At block 404, data from the image capture device is received. At block 406, a characteristic of the received data is determined. At block 408, the received data is stored into a solid state memory medium when the determined characteristic corresponds to a first predefined characteristic. At block 410, the received data is stored into a removable memory medium when the determined characteristic corresponds to a second predefined characteristic. The process ends at block 412.

1. A data storage apparatus arranged to be disconnectably coupled to a host device, the data storage apparatus, comprising:
a first data storage device arranged to store data received from the host device; and
a data transfer device arranged to receive a removable data storage medium and arranged to store data received from the host device on the removable data storage medium,
wherein the data storage apparatus is arranged to store data selectively on at least one of the first data storage device and the removable data storage medium.

2. The data storage apparatus of claim 1, wherein the host device is an image capture device and the received data is image data received from the host device.

3. The data storage apparatus of claim 1, wherein the received data is stored concurrently on both the first data storage device and the removable data storage medium.

4. The data storage apparatus of claim 1, wherein the data storage apparatus is arranged to store data to a selected one of the first data storage device and the removable data storage medium.

5. The data storage apparatus according to claim 1, wherein the data storage apparatus is arranged to store still photography data to the first data storage device and is arranged to store video data to the removable data storage medium.

6. The data storage apparatus according to claim 1, wherein said first data storage device comprises a solid state memory device.

7. Data storage apparatus according to claim 1, wherein said data transfer device comprises at least one selected from a group consisting of an optical disk drive, a magnetic disk drive and a solid state memory read/write device.

8. The data storage apparatus according to claim 1, wherein said first data storage device is arranged to periodically transfer data stored thereon to said further removable data storage medium received in the data transfer device.

9. The data storage apparatus according to claim 1, wherein the data storage apparatus further comprises a data controller arranged to control the flow of data between the host device and at least one of the first data storage device and the data transfer device.

10. The data storage apparatus according to claim 9, wherein said data controller is arranged to control the flow of data in accordance with a user initiated control signal.

11. The data storage apparatus according to claim 9, wherein the data controller is arranged to control the flow of data having a first predetermined characteristic between the host device and the first data storage device and to control the flow of data having a second predetermined characteristic between the host device and data transfer device.

12. The data storage apparatus according to claim 11, wherein the first predetermined characteristic corresponds to still photography data and the second predetermined characteristic corresponds to video data.

13. The data storage apparatus according to claim 11, wherein at least one of the first and second predetermined characteristics comprises the data format.

14. The data storage apparatus according to claim 9, wherein said data controller is programmed to receive data from the first data storage device, manipulate said data so as to reformat said data and send said reformatted data to said data transfer device.

15. The data storage apparatus according to claim 9, wherein said data controller is re-programmable.

16. The data storage apparatus according to claim 1, further comprising a casing wherein said data storage apparatus resides, wherein the casing has substantially identical external physical dimensions as a solid state memory card that is arranged to be disconnectably coupled to the host device.

17. The data storage apparatus according to claim 1, wherein the data transfer device is arranged to receive a removable data storage medium having a greater data storage capacity than the first data storage device.

18. A data storage device for providing storage of data from a digital device, the data storage device comprising:
an interface configured to enable the data storage device to be disconnectably coupled to a digital device;
a first data storage medium coupled to the interface and arranged to selectively store data received from the digital device via the interface; and
a data transfer device coupled to the interface and configured to receive a second, removable, data storage medium, the data transfer device being arranged to selectively store data received from the digital device via the interface on the second, removable, data storage medium.

19. The data storage device of claim 18, wherein the digital device is an image capture device and the received data is image data received from the digital device.

20. The data storage device of claim 18, wherein the received data is stored concurrently on both the first data storage medium and the second, removable, data storage medium.

21. The data storage device of claim 18, wherein the data storage device is arranged to store data to a selected one of the first data storage device and the second, removable, data storage medium.

22. The data storage device of claim 18, wherein the received data is stored selectively on one of the first data storage medium and the second, removable, data storage medium.

23. The data storage device of claim 18, wherein the data storage device is arranged to store still photography data to the first data storage device and is arranged to store video data to second, removable, data storage medium.

24. A data storage apparatus for providing storage of data from a host device, the data storage apparatus comprising:
an interface providing means for disconnectably coupling the data storage apparatus to the host device;
a first data storage device arranged to selectively store data received from the host device;
a data transfer device configured to removably receive a second data storage device and arranged to selectively store data received from the host device on the second data storage device; and
a data controller arranged to control the selection of each of the first data storage device and the data transfer device and control the storage of data received from the host device thereon.

25. The data storage apparatus of claim 24, wherein the data storage device is arranged to store data to a selected one of the first data storage device and the second data storage device.

26. The data storage apparatus of claim 24, wherein the received data is stored selectively on one of the first data storage device and the second data storage device.

27. The data storage apparatus of claim 24, wherein the first data storage device comprises a solid state memory and the second data storage device comprises an optical disk.

28. The data storage apparatus of claim 27, wherein the second data storage device comprises a mini optical disk.

29. A data storage apparatus for providing storage of data from a host device, the data storage apparatus comprising:
connection means for disconnectably coupling the data storage apparatus to a host device;
a data storage means for storing data received from the host device;
data transfer means for storing data received from the host device on a removable data storage medium, the data transfer means being arranged to be disconnectably coupled to the removable data storage medium; and
data flow control means for controlling the flow of data received from the host device to each of the data storage means and the data transfer means in accordance with at least one data flow scheme selected from periodically transferring data stored on the data storage means to the removable data storage medium, coupled to the data transfer means, storing data having a first data format on the data storage means and storing data having a second data format on the removable data storage medium coupled to the data transfer means, and controlling the flow of data in accordance with a user initiated control signal.

30. The data storage device of claim 29, wherein the first data format corresponds to still photography data.

31. The data storage device of claim 29, wherein the second data format corresponds to video data.

32. An image capture device, comprising:
an interface arranged to be disconnectably coupled to either a data storage apparatus and a conventional memory device;
a processor configured to discover if the image capture device is coupled to the data storage apparatus or the conventional memory device; and
a data controller arranged to control the flow of data from the image capture device in accordance to at least one criteria when the image capture device is coupled to the data storage apparatus,
wherein the data storage apparatus comprises a first data storage device and a data transfer device arranged to receive a removable data storage medium, and wherein the data storage apparatus stores the data received from the image capture device selectively into one of the first data storage device and the removable data storage medium depending upon the criteria.

33. A image capture device according to claim 32, wherein the data controller is arranged to control the flow of data having a first predetermined characteristic between the image capture device and the first data storage device and to control the flow of data having a second predetermined characteristic between the image capture device and data transfer device.

34. The data storage device of claim 33, wherein the received data is stored into a solid state memory medium when the determined criteria corresponds to still photography data.

35. The data storage device of claim 33, wherein the received data is stored into the removable memory medium when the determined criteria corresponds to video data.

36. The image capture device according to claim 33, wherein at least one of the first and second predetermined characteristics comprises the data format.

37. The image capture device according to claim 32, wherein said data controller is arranged to control the flow of data in accordance with a user initiated control signal.

38. A method for storing data received from an image capture device into a storage apparatus disconnectably coupled to the image capture device, comprising:
receiving data from the image capture device;
determining a characteristic of the received data;
storing the received data into a solid state memory medium when the determined characteristic corresponds to a first predefined characteristic; and
storing the received data into a removable memory medium when the determined characteristic corresponds to a second predefined characteristic.

39. The data storage device of claim 38, further comprising storing the received data into the solid state memory medium when the determined characteristic corresponds to still photography data.

40. The data storage device of claim 38, further comprising storing the received data into the removable memory medium when the determined characteristic corresponds to video data.

41. The data storage device of claim 38, wherein storing the received data into the removable memory medium further comprises storing the received data onto an optical disk.

42. The data storage device of claim 38, wherein storing the received data into the removable memory medium further comprises storing the received data onto a mini optical disk.

43. The data storage device of claim 38, wherein storing the received data into the removable memory medium further comprises storing the received data onto a magnetic medium.

44. A system for storing data received from an image capture device into a storage apparatus disconnectably coupled to the image capture device, comprising:
means for receiving data from the image capture device;
means for determining a characteristic of the received data;
means for storing the received data into a solid state memory medium when the determined characteristic corresponds to a first predefined characteristic; and
means for storing the received data into a removable memory medium when the determined characteristic corresponds to a second predefined characteristic.

45. The system of claim 44, wherein the first predefined characteristic corresponds to still photography data.

46. The system of claim 44, wherein the second predefined characteristic corresponds to video data.

47. The system of claim 44, wherein the means for storing the received data into a removable memory medium further comprises means for storing the received data onto an optical disk.

48. A program for operating a microprocessor and stored in a storage apparatus that is arranged to be disconnectably coupled to an image capture device, the program comprising logic configured to perform:
receiving data from the image capture device;
determining a characteristic of the received data;
storing the received data into a solid state memory medium residing in the storage apparatus when the determined characteristic corresponds to a first predefined characteristic; and
storing the received data into a removable memory medium residing in the storage apparatus when the determined characteristic corresponds to a second predefined characteristic.

49. The program of claim 38, further comprising logic configured to perform storing the received data into a solid state memory medium when the determined characteristic corresponds to still photography data.

50. The program of claim 38, further comprising logic configured to perform storing the received data into a removable memory medium when the determined characteristic corresponds to video data.
